(19) United States
(12) Patent Application Publication
(10) Pub. No.: US 2025/0026038 A1
(43) Pub. Date: Jan. 23, 2025

(54) CUTTING METHOD OF A LAYER OF CERAMIC POWDER MATERIAL, MANUFACTURING PROCESS AND MANUFACTURING PLANT OF CERAMIC ARTICLES

(71) Applicant: SACMI COOPERATIVA MECCANICI IMOLA SOCIETA' COOPERATIVA, IMOLA (IT)

(72) Inventors: Paolo GONNI, IMOLA (IT); Alessandro FABBRONI, IMOLA (IT)

(21) Appl. No.: 18/715,685

(22) PCT Filed: Nov. 30, 2022
(86) PCT No.: PCT/IB2022/061595

§ 371 Date: May 31, 2024

(30) Foreign Application Priority Data
Dec. 1, 2021 (IT) 102021000030488

(51) Int. Cl. B26F 3/00; B24C 1/04; B24C 3/08; B24C 3/12; B24C 3/32; B28B 11/16; B28B 17/00

(52) U.S. Cl. CPC B26F 3/004; B24C 1/045; B24C 3/083; B24C 3/085; B24C 3/12; B24C 3/32; B28B 11/165; B28B 17/0036

(57) ABSTRACT

Cutting method of a layer(S) of ceramic powder material having a modulus of rupture that is smaller than about 10 N/mm², comprising: a step of moving the layer(S) of ceramic powder material along a given path (P) in a moving direction (A) through a cutting station; and a cutting step, during which at least a first water-jet cutting device cuts said layer(S) of ceramic powder material along a first direction (D1) that is transverse to the moving direction (A), so as to cut said layer(S) of ceramic powder material and obtain a plurality of articles of ceramic powder material (MCP).

### CROSS-REFERENCE TO RELATED APPLICATIONS

This patent application claims priority from Italian Patent Application No. 102021000030488 filed on Dec. 1, 2021 the entire disclosure of which is incorporated herein by reference.

### SECTOR OF THE ART

The present invention relates to a cutting method of a layer of ceramic powder material, and to a manufacturing process and manufacturing plant of ceramic articles.

In particular, the present invention finds advantageous application in the field of production of ceramic articles, such as ceramic tiles and slabs of various formats, to which the following description will make explicit reference without losing generality.

### BACKGROUND OF THE INVENTION

In the field of the production of ceramic articles (in particular, slabs; more in particular, tiles) there are known manufacturing plants that provide for the feeding (typically in a substantially continuous manner) of semi-dry ceramic powder (i.e. with a moisture content that is lower than 12%, in particular ranging from 5% to 7%) along a given path through a continuous compaction assembly, which subjects the ceramic powder to a compaction pressure, so as to obtain a band of compacted ceramic powder, which is subsequently cut to obtain a plurality of articles of compacted ceramic powder, having different dimensions according to the type of ceramic article to be obtained, which will then be dried, possibly decorated, and fired in order to obtain the final ceramic products.

The known cutting methods and systems generally provide for a cutting station in which abrasive tools, typically grinding wheels or rotating blades or cylindrical cutters, intercept and cut the band of compacted ceramic powder, generating articles of compacted ceramic powder of various dimensions that are then subjected to subsequent drying, decoration and firing operations.

However, the known methods and systems have drawbacks, including the following.

The cutting systems and methods of the known type envisage using abrasive tools which, besides being very expensive in themselves, are subject to wear and require frequent maintenance and/or replacement operations that can only be performed by stopping the manufacturing cycle with further obvious disadvantages in terms of costs, times and production efficiency.

In addition, the cutting systems and methods of known type present numerous issues related to the large amount of waste powder produced by the abrasive tools during cutting, which, if not recovered by appropriate expensive suction systems, risks dirtying the plant compromising the operation of the components of the plant and/or the aesthetic appearance of the final ceramic articles.

In addition, in the cutting systems and methods of known type, the cutting tools are not able to completely pass through the layer of powder, leaving in the lower end area of the section a small burr that must be removed with other work stations before the firing step. This deburring represents a plant complication and an increase in the cost of the plant.

### DISCLOSURE OF THE INVENTION

Aim of the present invention is to provide a cutting method, a manufacturing process and manufacturing plant of ceramic articles, which make it possible to overcome, at least partially, the drawbacks of the known art and are, at the same time, easy and economical to manufacture.

In accordance with the present invention, there are provided a cutting method and a manufacturing process and manufacturing plant of ceramic articles as claimed in the independent claims below and, preferably, in any of the claims dependent directly or indirectly on the independent claims.

The claims describe preferred embodiments of the present invention.

### BRIEF DESCRIPTION OF THE DRAWINGS

The present invention will now be described with reference to the enclosed drawings, showing some non-limiting embodiments thereof, wherein:

FIG. 1 is a schematic side view of part of a manufacturing plant to manufacture ceramic articles in accordance with an embodiment of the invention;

FIG. 2 is a schematic side view of part of a manufacturing plant to manufacture ceramic articles in accordance with a further embodiment of the invention;

FIG. 2A is a schematic side view of part of a manufacturing plant to manufacture ceramic articles in accordance with yet another embodiment of the invention;

FIGS. 3 to 6 show schematic views of successive steps of the cutting method in accordance with respective different embodiments of the present invention; and

FIG. 7 shows a schematic view of a part of a water recovery assembly used during the cutting operations in the plant of FIGS. 1, 2 and 2A.

### PREFERRED EMBODIMENTS OF THE INVENTION

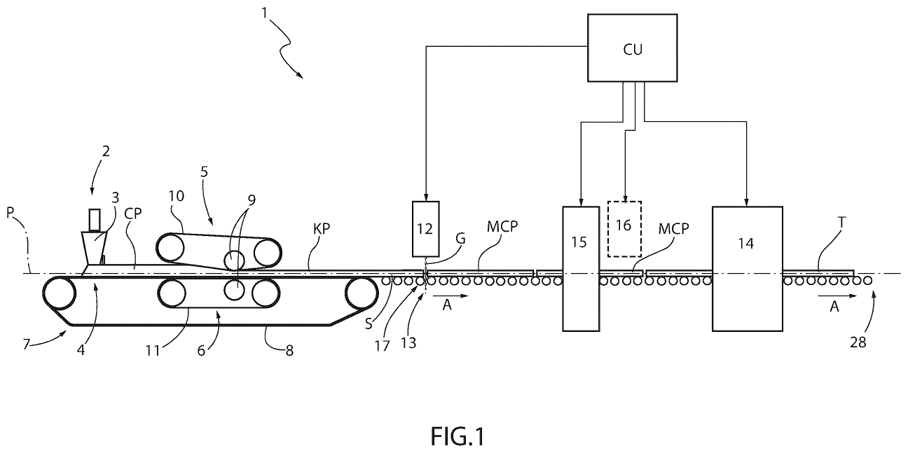

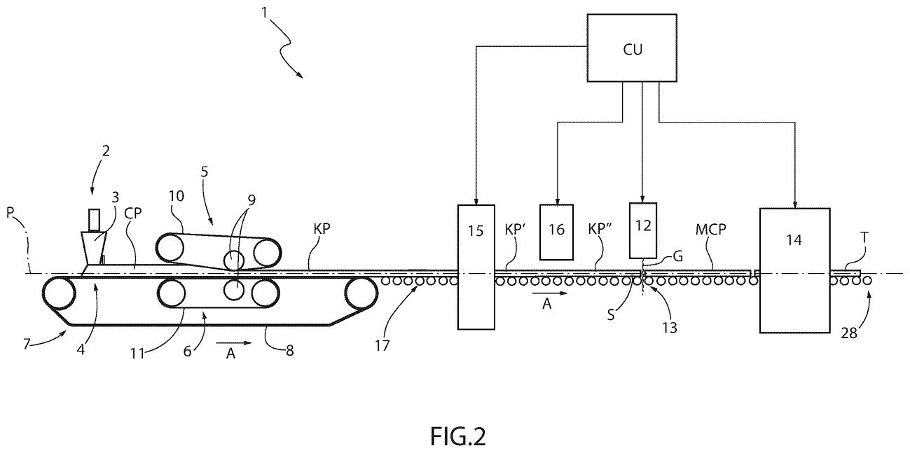

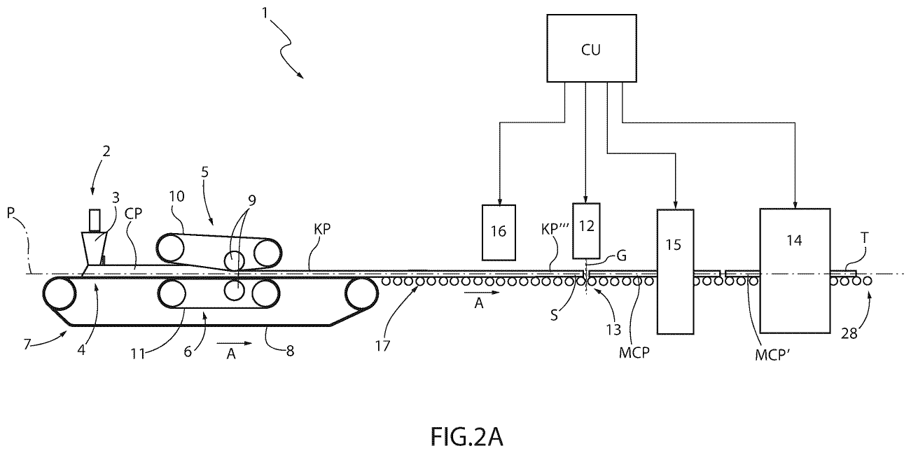

In accordance with a first aspect of the present invention, in FIGS. 1, 2 and 2A, 1 denotes as a whole a manufacturing plant to manufacture ceramic articles T (partially and schematically shown in FIGS. 1 and 2). In particular, the ceramic articles T are substantially (but not necessarily) flat articles, in particular ceramic slabs; more precisely ceramic tiles of different formats, for example of large dimensions such as those having a section of 1200/1800×2400/3600 mm, or of smaller dimensions having a section from 900/1200×1800/2000 mm, up to 400×400 mm), etc. having a thickness ranging from 3 to 50 mm, preferably from 3 to 30 mm.

With particular reference to FIGS. 1, 2 and 2A, advantageously but not in a limiting manner, the production plant of ceramic articles 1 T comprises: a feeding assembly 2, advantageously provided with at least one feeding device 3 (of a known type, not further described herein) and configured to feed the ceramic powder CP (in particular, an amount—i.e. a given mass—of not compacted ceramic powder CP) at an input station 4; a compaction device 5, which is arranged at a compaction station 6, and is configured to apply a compaction pressure to the (not compacted) ceramic powder CP so as to compact it and obtain a band of compacted ceramic powder KP; and a conveyor assembly 7 which is configured to transport along a given path P in a moving direction A the ceramic powder CP from the input station 4 to the compaction station 6 and the band of compacted ceramic powder KP at least out of the compaction station 6.

Advantageously but not in a limiting manner, the ceramic powder CP (i.e. a semi-dry mixture, in particular having a moisture content ranging from 5% to 7%) is mainly silicate-based, i.e. it comprises at least about 35% (in particular, at least about 40%) by weight relative to the total weight of the silica ceramic powder CP (SiO₂) and less than about 50% (in particular, less than about 30%) by weight, relative to the total weight of the ceramic powder CP, of alumina (Al₂O₃).

According to some non-limiting embodiments (such as those schematically shown in FIGS. 1 and 2), the conveyor assembly 7 comprises at least one conveying device 8 (in particular, a conveyor belt) for transporting the ceramic powder CP at least from the input station 4 to the compaction station 6 and the compaction device 5 comprises (in particular, consists of) a continuous compaction assembly (in itself known). In particular, according to some non-limiting embodiments (such as those shown in FIGS. 1 and 2), the continuous compaction assembly comprises at least two compression rollers 9 which are arranged on opposite sides of the (in particular, one above and one below) conveying device 8 to exert a pressure on the (not compacted) ceramic powder CP so as to compact it and obtain the band of compacted ceramic powder KP. Furthermore, advantageously but not necessarily (like for example shown in FIGS. 1 and 2), the compaction device 5 (i.e. the continuous compaction assembly) comprises: a pressure belt 10, advantageously of metal, which converges towards the conveying device 8 (in particular, towards the conveyor belt) in the moving direction A so as to exert on the ceramic powder CP a pressure (from top to bottom) which gradually increases in the moving direction A; and possibly but not necessarily a contrast belt 11, advantageously made of rubber or similar material, arranged on the opposite side of the conveying device 8 (in particular, of the conveyor belt) relative to the pressure belt 11 to provide an adequate response to the downward force exerted by the pressure belt 11.

Advantageously, the manufacturing plant 1 to manufacture ceramic articles T also comprises a cutting system 12 arranged at a cutting station 13 and configured to cut a layer S of ceramic powder material, having a breaking load, measured in accordance with EN ISO 10545 Part 4, which is smaller than about 10 N/mm², in particular smaller than about 8 N/mm², to obtain articles of ceramic powder material MCP; and a firing kiln 14 (in itself known and not further described herein) which is arranged downstream of the cutting system 12 along the moving direction A to fire the articles of ceramic powder material MCP, advantageously imposing a firing temperature of about 1000-1300° C., so as to obtain ceramic articles T, in particular ceramic slabs, even more in particular ceramic tiles.

The conveyor assembly 7 is, therefore, also configured to convey the layer S of ceramic powder material at least through the cutting station 13 and the articles of ceramic powder material MCP from the cutting station 13 to the firing kiln 14 (possibly passing through a drier 15 and/or a decoration unit 16—as shown for example in FIG. 1).

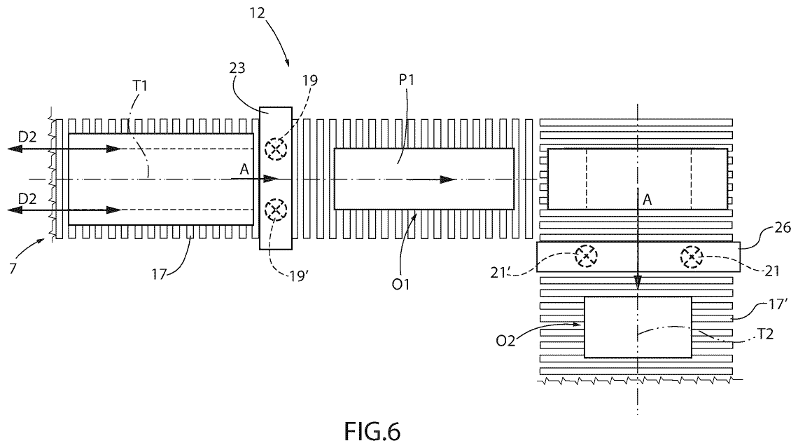

In detail, advantageously but not in a limiting manner, the conveyor assembly 7 also comprises at least a further conveyor device 17, for example a roller conveyor (like in the embodiments of FIGS. 1 to 5) or a conveyor belt (like in the embodiments of FIG. 6) which is arranged downstream of the conveying device 8 along the moving direction A and is configured to receive the layer S of ceramic powder material and convey it at least through the cutting station 13, where the articles of ceramic powder material MCP are obtained and another conveyor device, which according to some embodiments (like for example those shown in FIGS. 1 and 2 and 2A) coincides with the conveyor device 17, in order to convey these articles of ceramic powder material MCP, at least through the kiln 14 and up to an output station 28 (possibly passing through a drier 15 and/or a decoration unit 16).

According to some advantageous but not limiting embodiments (such as those schematically shown in FIGS. 1, 2 and 2A), the manufacturing plant 1 to manufacture ceramic articles T also comprises a drier 15 (in itself known and not further described here) which is arranged downstream of the compaction device 5 and upstream of the firing kiln 14 along the moving direction A and is configured to dry the layer S of ceramic powder material (in particular, the band of compacted ceramic powder KP to obtain a dried band of ceramic powder KP′, or the articles of ceramic powder material MCP that are already cut and possibly also already enamelled, as will be explained later in this discussion), in particular imposing a temperature of at least about 120-300° C.

Furthermore, according to yet some advantageous but not limiting embodiments, the manufacturing plant 1 to manufacture ceramic articles T, also comprises a decoration unit 16 (in itself known and not further described herein) which is configured to apply at least some enamel on the layer S of ceramic powder material (in particular, on the dried band of ceramic powder KP′ so as to obtain an enamelled band of ceramic powder KP″, or on the band of compacted ceramic powder KP so as to obtain an enamelled band of ceramic powder KP′″ or on the already cut and dried articles of ceramic powder material MCP, as will be explained later in this discussion).

In particular, in the present discussion, the term “layer S of ceramic powder material” refers to a layer comprising (in particular, consisting of) ceramic powder CP which is compacted by means of the compaction device 5 but not yet fired. In particular (as will be clearer from the following description of some embodiments of the invention), in some non-limiting cases (such as the one shown in FIG. 1) the “layer S of ceramic powder material” comprises (in particular, coincides with) the band of compacted ceramic powder KP or its part. According to other non-limiting embodiments (such as the one shown in FIG. 2), the “layer S of ceramic powder material” comprises (in particular, is made up of) the treated (i.e. dried and possibly enamelled) band of compacted ceramic powder KP; in other words, the layer “layer S of ceramic powder material” comprises (in particular, coincides with) the dried band of ceramic powder KP′ or with the enamelled band of ceramic powder KP″ or their part. According to yet other non-limiting embodiments (such as the one shown in FIG. 2A), the “layer S of ceramic powder material” comprises the (in particular, is made up of) the enamelled band of ceramic powder KP″′ or its part.

Advantageously but not in a limiting manner, the aforementioned layer S of ceramic powder material exhibits a loss on ignition (which is a measure of the weight variation of a dried sample measured at about 100° C. after it has been heated at a high temperature above 1000° C. causing combustion and volatilization of part of its content) that is ranging from about 1% to about 80% of the initial weight.

Advantageously, the cutting system 12 comprises at least one water-jet cutting device 21, which is advantageously arranged at a transverse cutting site 22, and is configured to cut the layer S of ceramic powder material along a direction D1 that is orthogonal (in particular, transverse) to the moving direction A. Even more advantageously but not in a limiting manner, the cutting system 12 also comprises at least a further water-jet cutting device 19, which is advantageously arranged at a longitudinal cutting site 20, and is configured to cut the layer S of ceramic powder material along a direction D2 which is parallel to the moving direction A so as to obtain articles of ceramic powder material MCP.

In detail, advantageously, each water-jet cutting device 19, 21 comprises a respective nozzle (not visible in the attached Figures) which is arranged and configured to dispense a jet G of water under pressure (schematically shown in FIGS. 1, 2 and 2A) towards the layer S of ceramic powder material so as to intercept and cut the layer S of ceramic powder material itself; in particular, each water-jet cutting device 19, 21 is configured to dispense the jet G of water under pressure on a surface, advantageously on an upper surface, of the layer S of ceramic powder material so as to cut the layer S of ceramic powder material.

It is understood that according to further non-limiting and not shown embodiment, the water-jet cutting devices 19, 21 could be arranged below the conveying assembly 7, in particular below the conveyor device 17, so as to dispense the jet on a lower surface of the layer S of ceramic powder material or a portion P1 thereof.

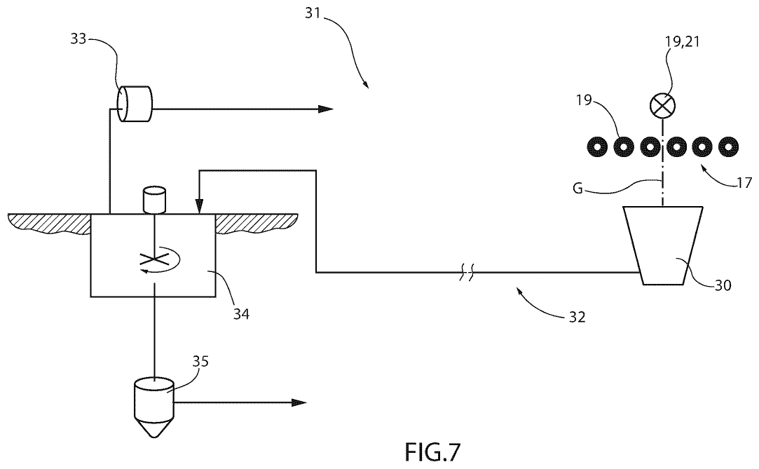

Advantageously but not in a limiting manner, the conveyor device 17 comprises (in particular, is made up of) a roller conveyor or a belt or a net having, at the cutting station 13, openings 29 (at least in a number equal to the number of water-jet cutting devices 19, 19′, 21, 21′) to allow the passage of the jet G of water under pressure during cutting (see the schematic representation of FIG. 7).

According to some advantageous but not limiting embodiments such as the one schematically shown in FIG. 7, the manufacturing plant 1 to manufacture ceramic articles T comprises at least one collection device 30 (in itself known and schematically shown in FIG. 7) which is configured and arranged (relative to the cutting system 12) to receive and collect the aforementioned jet G of water under pressure after it has crossed the layer S of ceramic powder material and the aforementioned openings 29.

Alternatively or in addition, advantageously but not in a limiting manner, the cutting station 13 could be protected by a protection system (not shown and in itself known) and/or provided with suction devices to avoid the risk of (excessive) dispersion of water in the plant 1.

Advantageously but not necessarily, the nozzle of each cutting device 19, 21 comprises an outlet hole having a diameter of about 0.10-1.00 mm (in particular, 0.20-0.70 mm) and is configured to dispense the jet G of water under pressure so that it intercepts this layer S of ceramic powder material (in particular the upper surface thereof) with a pressure that is greater than about 1500 bar; in particular, greater than about 3000 bar; even more in particular, greater than about 3600 bar; and advantageously but not in a limiting manner smaller than about 6000 bar.

Advantageously but not in a limiting manner, the water under pressure of the jet G of water under pressure comprises (in particular, is made up of) pure water and at most about 10 g/l (in particular, at most about 5 g/l; even more in particular, at most about 2 g/l) of solid particles. Even more advantageously but not in a limiting manner, the jet G of water under pressure comprises (in particular, is made up of) pure water and from about 0 (excluded) g/l (in particular, from about 0.3 g/l) to about 10 g/l (in particular, to about 5 g/l; even more in particular, to about 2 g/l) of solid particles (in other words, the jet G of water under pressure comprises pure water and an amount of solid particles varying from about 0 (excluded) g/l—in particular, from about 0.3 g/l-to about 10 g/l—in particular, to about 5 g/l-even more in particular, to about 2 g/l). The aforementioned solid particles, advantageously but not in a limiting manner, have an equivalent diameter which is smaller than about 10 μm (in particular, smaller than about 1 μm). Surprisingly, the present invention allows an optimal cutting of the layer S of ceramic powder material even using substantially pure water.

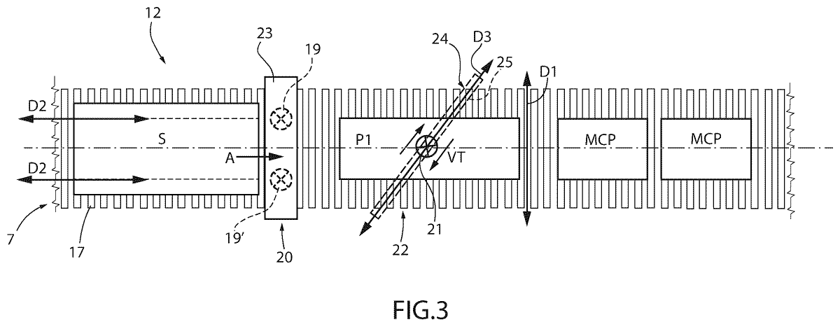

Even in more detail, according to some advantageous but not limiting embodiments (such as the one schematically shown in FIGS. 1 and 3), the cutting system 12 is arranged downstream of the compaction device 5 and upstream of the drier 15 and the layer S of ceramic powder material coincides with the band of compacted ceramic powder KP (which is cut in the cutting station 13 giving rise to the articles of ceramic powder material MCP that will then be dried and enamelled). Advantageously, in this case, the use of the above-described water-jet cutting devices 19, 21 allows a neat cut to be obtained without generating surpluses/irregularities or burrs (i.e. protruding parts) along the cut edge. This, in addition to improving the quality of the cut, can allow to eliminate the deburring operation to which the articles of ceramic powder material MCP are currently subjected after cutting, with obvious economic and operational advantages.

According to advantageous but not limiting alternative embodiments (such as the one schematically shown in FIGS. 2, 4, 5 and 6), the cutting system 12 is arranged downstream of the drier 15 and, when present, of the decoration unit 16, and the layer S of ceramic powder material coincides with the band of compacted ceramic powder KP′ or with the enamelled band of ceramic powder KP″ (which is then cut giving rise to already enamelled and possibly dried articles of ceramic powder material MCP′ which are thus ready for firing). In this way, advantageously (relative to the cutting carried out before drying) the compaction, drying and decoration operations are carried out on a single band of ceramic powder material regardless of the formats of the ceramic articles T that are intended to be produced, which makes it possible to simplify and speed up the drying and enamelling steps.

According to yet other embodiments (such as the one schematically shown in FIG. 2A), the cutting system 12 is arranged downstream of the decoration unit 16 and upstream of the drier 15, and the layer S of ceramic powder material coincides with the enamelled band of ceramic powder KP′″ (which is then cut giving rise to already enamelled and dried articles of ceramic powder material MCP′ which are thus ready for firing).

Advantageously but not in a limiting manner, according to some embodiments schematically shown in FIGS. 3 to 6, the cutting system 12 comprises at least two water-jet cutting devices 19 and 19′ which are arranged in the longitudinal cutting site 20 substantially side by side with each other transversely to the moving direction A (in particular, in a fixed position) so as to dispense the respective jet G of water at two fixed points of said longitudinal cutting site 20, so as to intercept the layer S of ceramic powder material that moves along the moving direction A along two substantially linear and parallel cutting paths.

Even more advantageously, according to some non-limiting embodiments (which are particularly advantageous when the layer S of ceramic powder material coincides with the band of compacted ceramic powder KP or with the enamelled band of ceramic powder KP′″ and the cutting system 12 is arranged upstream of the drier 15), the two water-jet cutting devices 19 and 19′ are side by side transversely to the moving direction A spaced apart from each other, dispensing the jet G of water under pressure so as to remove two opposite side end portions of the layer S of ceramic powder material while this moves along the moving direction A by performing the so-called trimming operation and obtaining a portion (i.e. strip) P1 of said layer S of ceramic powder material. Alternatively, according to other embodiments not shown (and which are particularly advantageous when the layer S of ceramic powder material is made up of the dried band of ceramic powder KP′ or of the enamelled band of ceramic powder KP″ and the cutting system 12 is arranged downstream of the drier 15 or of the decoration station 16) the two (or more) water-jet cutting devices 19 and 19′ are side by side transversely to the moving direction A spaced apart from each other so as to cut the layer S of ceramic powder material into three (or more) portions (i.e. strips).

With particular reference to FIG. 3, in which the cutting system 12 is located downstream of the compaction device 5 and upstream of the drier 15, according to some advantageous but not limiting embodiments, the cutting system 12 comprises a support 23, for example a portal, which at least partly extends above the conveyor assembly 7, in particular the conveyor device 17, at the longitudinal cutting site 20 and carries the water-jet cutting device 19 (in particular, the water-jet cutting devices 19, 19′, each) connected to said support 23 so that, once it has been operated, it dispenses the respective jet G of water under pressure so as to intercept and cut the layer S of ceramic powder material (which moves along the moving direction A), when this is located at (goes through the area of) the longitudinal cutting site 20, thus obtaining the aforementioned portion (i.e. strip) P1 (or more portions/strips as explained above). The cutting system 12 further comprises a support structure 24 which (advantageously but not in a limiting manner, at least partly extends above the conveyor assembly 7, in particular the conveyor device 17,) carries the aforementioned water-jet cutting device 21 in a sliding manner, and can be operated so as to allow said water-jet cutting device 21 to translate along a direction D3, which is oblique relative to said moving direction A and to the first direction D1.

In particular (advantageously but not necessarily), in use, the control unit CU operates the support structure 24 and the water-jet cutting device 21 so that it is operated to dispense the respective jet G of water under pressure while translating along the direction D3. Advantageously but not in a limiting manner, the control unit CU is configured to operate the support structure 24 so as to allow the water-jet cutting device 21 to translate along said direction D3 at a translation speed VT which is a function of the inclination of said direction D3 relative to the moving direction A. In other words, the control unit CU is configured to ensure a synchronization between the translation speed VT of the water-jet cutting device 21 and the speed at which the layer S of ceramic powder material or the portion P1 thereof moves along the moving direction A so that said layer S of ceramic powder material or the portion P1 is cut along the transverse direction D1. Even in more detail, according to some advantageous but not limiting embodiments, the cutting speed VT is proportional to the speed at which the layer S of ceramic powder material or the portion P1 is moved along the moving direction A and the proportionality constant is a function of the inclination of said direction D3 relative to said moving direction A, advantageously it is equal to about the reciprocal of the cosine of the angle α of inclination that the direction D3 forms relative to the moving direction A.

Even more advantageously but not in a limiting manner, this direction D3 is inclined relative to the moving direction A by an angle α ranging from about 45° to about 80°.

According to some advantageous but not limiting variants, the support structure 24 comprises a guide 25 which extends above the conveyor assembly 7, in particular the conveyor device 17, along said direction D3, a sliding support body (not visible in the attached Figures) which supports the cutting device 21 and a drive (not shown in the attached Figures, for example a linear motor) which can be operated by the control unit CU to induce the translation of the sliding support body along the guide 25 while the layer S of compacted ceramic powder or a portion thereof P1 moves on the conveyor assembly 7, in particular on the conveyor device 17, advantageously at the translation speed VT.

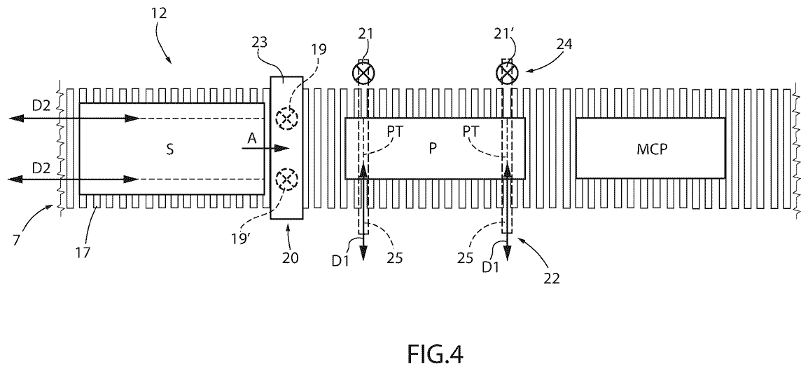

With particular reference to FIG. 4 in which the cutting system 12 is arranged downstream of the drier 15 and, when present, of the decoration unit 16, then the layer S of ceramic powder material comprises (in particular, coincides with) the dried band of ceramic powder KP′ or possibly the enamelled band of ceramic powder KP″, advantageously but not in a limiting manner, the cutting system 12 comprises: a support 23 (advantageously similar to that described above with reference to the embodiment of FIG. 3, for example a portal), which at least partly extends above the conveyor assembly 7, in particular the conveyor device 17, at the longitudinal cutting site 20 and carries the water-jet cutting device 19 (in particular the water-jet cutting devices 19, 19′, each) connected to said support 23 so that, once it has been operated, it dispenses the respective jet G of water under pressure so as to intercept and cut the layer S of ceramic powder material (which moves along the moving direction A), when this is located at (goes through the area of) the longitudinal cutting site 20, thus obtaining the aforementioned portion (i.e. strip) P1 (or more portions/strips as explained above). The cutting system 12 further comprises a support structure 24 which (advantageously but not in a limiting manner, at least partly extends above the conveyor assembly 7, in particular the conveyor device 17,) carries the water-jet cutting device 21 in a sliding manner in the area of a second cutting site 22, and can be operated so as to allow said water-jet cutting device 21 to translate along a cutting path PT which extends along the transverse direction D1 so that, in use, said water-jet cutting device 21 dispenses the respective jet G of water under pressure while moving along said path PT, when the layer S of ceramic powder material, or the portion P1, lies (i.e. is stationary) at the transverse cutting site 22.

In particular, in this case, the control unit CU is configured to control the conveyor assembly 7, in particular the conveyor device 17, so as to stop the layer S of ceramic powder material at the transverse cutting site 22, and subsequently activate the support structure 24 so as to induce the translation of the water-jet cutting device 21 so that the respective jet G of water under pressure intercepts and cuts the surface of the layer S of ceramic powder or a portion thereof along the transverse direction D1 so as to obtain the articles in ceramic powder material MCP.

In detail, advantageously but not in a limiting manner, also in this case, the support structure 24 comprises a guide 25 that extends above the conveyor assembly 7, in particular the conveyor device 17, along the transverse direction D1, a sliding support body (not visible in the attached Figures) that supports the cutting device 21 and a drive (not shown in the attached Figures, in itself known, for example a linear motor) that can be operated by the control unit CU to induce the translation of the sliding support body along said guide 25 while the layer S of ceramic powder material lies or the portion P1 (i.e. is stationary) at the transverse cutting site 22.

According to some advantageous but not limiting variants of such embodiments (such as the one shown in FIG. 4), the cutting system 12 comprises two water-jet cutting devices 21, 21′ carried by the same support structure 24 which can be operated (as mentioned above) to induce the translation of both the water-jet cutting devices 21, 21′ so that the respective jet G of water under pressure intercepts and cuts the surface of the layer S of ceramic powder or a portion thereof along two cutting paths PT which are parallel to the transverse direction D1 so as to obtain the aforementioned plurality of articles of ceramic material MCP.

Advantageously, but not in a limiting manner, in this case, the water-jet cutting devices 19, 19′, 21 and 21′ are carried, respectively, by the support 23 and by the support structure 24 so that the hole of the respective nozzle (of each water-jet cutting device 19, 19′, 21 and 21′ is located above the conveying plane at a distance (i.e. at an elevation) relative to the layer S of ceramic powder material or to the portion P1 (in particular, relative to the upper surface of the layer S of ceramic powder material or of said portion P1) that is smaller than about 15 mm, in particular smaller than about 10 mm. This position ensures an optimal cutting action by the jet G of water under pressure.

With particular reference to FIGS. 3, 5 and 6, advantageously but not in a limiting manner, the cutting system 12 is arranged downstream of the drier 15 and, when present, of the decoration unit 16, therefore the layer S of ceramic powder material comprises (in particular, is made up of) the dried band of compacted ceramic powder KP′ or possibly by the enamelled band of ceramic powder KP″, the given path P comprises, at the cutting station 13, two segments T1 and T2 which develop one after the other along said moving direction A. In detail (advantageously but not in a limiting manner), the segment T1 comprises (in particular, develops at least through) the longitudinal cutting site 20, while the segment T2 comprises (in particular, develops at least through) the transverse cutting site 22. Advantageously but not in a limiting manner, in this case, the cutting system 12 comprises: a support 23 (advantageously similar to that described above with reference to the embodiments of FIGS. 3 and 4, for example a portal) which at least partly extends above the conveyor assembly 7, in particular the conveyor device 17, along the segment T1 of the given path P and carries the water-jet cutting device 19 (in particular, the water-jet cutting devices 19, 19′, each) connected to said support 23 so that, once it has been operated, it dispenses the respective jet G of water under pressure so as to intercept and cut the layer S of ceramic powder material (which in the moving direction A), when this is located at (in particular, goes through the area of) the longitudinal cutting site 20 so as to obtain the aforementioned portion (i.e. a strip) P1 having a first orientation O1, such that its main development direction is substantially parallel to the moving direction A of the segment T1 of the given path P. The cutting system 12 further comprises a further support 26 (advantageously similar to the support 23, for example a portal) which at least partly extends above the conveyor assembly 7 along the segment T2 of the given path P and carries the water-jet cutting device 21 connected to said support 26 so that, once it has been operated, it dispenses the respective jet G of water under pressure so as to intercept and cut the portion P1 when it is located at (in particular, goes through the area of) the transverse cutting site 22 which is oriented with a second orientation O2, such that its main development direction is substantially perpendicular, in particular substantially transverse, to the moving direction A of the segment T2 of the given path P.

Advantageously but not in a limiting manner, the cutting system 12 comprises two water-jet cutting devices 21, 21′, which are arranged in the transverse cutting site 22 substantially side by side with each other transversely to the moving direction A so that once they have been operated they dispense the respective jet G of water at two fixed points of the transverse cutting site 22 while the portion P1 is located (in particular, goes through) along the segment T2 of the given path P. Even more advantageously, the cutting devices 21, 21′ are carried by such further support 26 and placed side by side with each other, as mentioned above for the transverse cutting devices 19, 19′.

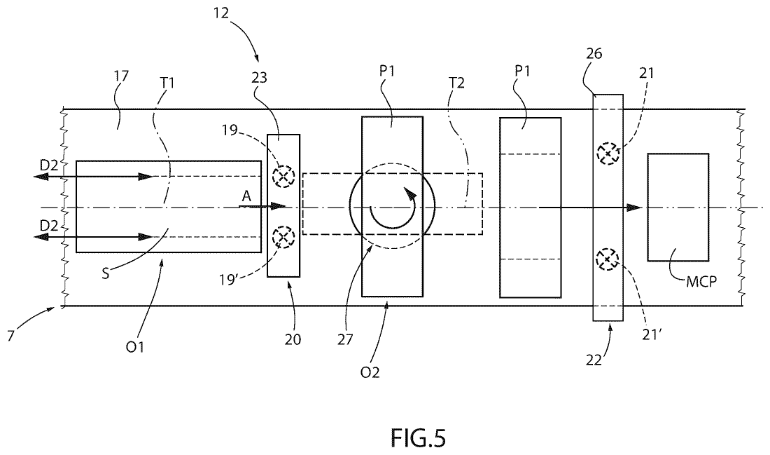

In detail, according to some non-limiting variants of such embodiments (such as the one shown in FIG. 5), the cutting system 12 comprises: a deflector assembly 27 (only schematically shown in FIG. 5), which is arranged immediately downstream of the support 23 and immediately upstream of the further support 26 along the moving direction A and is configured to rotate the portion P1 of the layer S of ceramic powder material by about 90° until it is led to assume the aforementioned second orientation O2. In this case advantageously, the two segments T2 and T1 of the given path P develop parallel to each other and one after the other along the same moving direction A.

In detail, advantageously but not in a limiting manner, the deflection assembly 27 comprises (in particular, is made up of) at least two guide bars which are arranged on the conveyor assembly 7, in particular on the conveyor device 17, and which can be operated, by the control unit CU, to intercept two orthogonal sides of the portion P1 of the layer S of ceramic powder material and induce the aforementioned rotation thereof by about 90°. Alternatively, the deflection assembly 27 could comprise a gripping system that grips and moves the (i.e., each) portion P1 of the layer S of ceramic powder material.

According to another variant schematically shown in FIG. 6, the cutting system 12 does not comprise the deflection assembly 27 and the conveyor assembly 7 is configured to allow the change of orientation of the portion P1 from the orientation O1 (out of the longitudinal cutting site 20) to the orientation O2 (at the inlet to the transverse cutting site 22). In detail, in this case, advantageously, the conveyor assembly 7 comprises, at the cutting station 13, two conveyor devices 17 and 17′ which extend orthogonal to each other (like for example in the embodiment shown in FIG. 6). In detail, advantageously, the conveyor device 17 is configured to receive and move the layer S of ceramic powder material along the segment T1 of the given path P through the longitudinal cutting site 20 described above and the conveyor device 17′, is arranged flush with the conveyor device 17 in order to receive the portion P1 out of the conveyor device 17 and move it along the segment T2 of the given path P through the transverse cutting site 22. In detail, in this case, advantageously but not in a limiting manner, the control unit CU is configured to operate the conveyor device 17 to convey the layer S of ceramic powder material along the segment T1 in the moving direction A up to the longitudinal cutting site 20 (where it is cut, as better explained above, so as to obtain the aforementioned portion P1) and the portion P1 along the segment T1 towards the conveyor device 17′; and the conveyor device 17′ to convey the portion P1 along the segment T2 of the given path P through the transverse cutting station 22 and the articles of ceramic powder material MCP, obtained after cutting, out of the cutting station 13.

Also in this case, advantageously but not in a limiting manner, the cutting devices 19, 19′, 22 and 21′ are carried, respectively, by the support 23 and by the support 26 so that the hole of the respective nozzle of each water-jet cutting device 19, 19′, 22 and 21′ is located above the conveying plane at a distance (i.e. at an elevation) relative to the layer S of ceramic powder material or to the portion P1 (in particular, relative to the upper surface of the layer S of ceramic powder material or to the portion P1) that is smaller than about 15 mm, in particular smaller than about 10 mm. This position ensures an optimal cutting action by the jet of water under pressure.

It is understood that according to other non-limiting embodiments not shown, each cutting device 19, 19′, 21 and 21′ could be carried by the respective support 23, 26 or by the support structure 24 so as to be able to adjust, manually or through the control unit CU, the distance of the hole of the respective nozzle relative to the layer S of ceramic powder material or of the portion P1 (in particular, relative to the upper surface of the layer S of ceramic powder material or of the portion P1).

It goes without saying that according to other non-limiting embodiments not shown, each cutting device 19, 19′, 21 and 21′ could be connected to one end of a respective anthropomorphic robot operated by the control unit CU to move along given trajectories during the cutting operations described above. In particular, the use of anthropomorphic robots makes it possible to create non-rectilinear cutting profiles (for example, wavy or jagged lines to imitate natural materials, etc.). Furthermore, this case, advantageously but not necessarily, the anthropomorphic robot could be configured to also carry the aforementioned collection device 30 (comprising—in particular made up of—a collection cup) arranged below the aforementioned openings 29 provided on the conveyor device 29 so as to collect the water of the jet G of water under pressure.

According to some advantageous but not limiting embodiments not shown, the manufacturing plant 1 to manufacture ceramic articles T, in particular the cutting system 12 comprises a recovery assembly 31 (schematically shown in FIG. 7) which is configured to collect and recover the water of the jet G of water under pressure of each water-jet cutting device 19, 19′, 21, 21′ of the cutting system 12.

According to some advantageous but not limiting embodiments such as the one schematically shown in FIG. 7, the recovery assembly 31 comprises a collection container 30 which (advantageously but not in a limiting manner coincide with the aforementioned collection device 30) is configured to contain a certain volume of water in order to attenuate the force of the jet G that arrives at the collection container (“to mitigate” the jet) and a system of ducts 32, by means of which the water of the jet G of water under pressure is conveyed (from the collection container 30) towards another point of the plant 1 where it will be reused in other operations (as explained below).

In particular, according to some advantageous but not limiting embodiments, the system of ducts 32 is configured to convey the water of the jet G of water under pressure from the collection container 30 to a ceramic mixture preparation station, where such water is used as normal process water within the grinding mill 33, possibly after having passed into a stirring or storage tank 34 (see FIG. 7). Alternatively or in combination, the system of ducts 32 is configured to convey the water of the jet G of water under pressure from the collection container 30 to a water treatment device 35 (e.g., a decanter) which is configured to treat the water of the jet G of water under pressure, separating it from the particles of ceramic material that might have been incorporated into the jet G of water under pressure during cutting, possibly passing through the stirring or storage tank 34. This water can then be used, for example, to wash other parts of the plant 1. In this way, a complete recovery of the water used for the cutting operations is achieved with consequent economic and environmental benefits. Furthermore, the use of a jet G of water under pressure such as the one described above allows immediate recovery of the water in the plant 1 which would not be possible (until after expensive operations of separation of the abrasive material from the water of the jet G of water under pressure) if the jet G of water under pressure had higher percentages of dissolved solid particles and/or if such particles had a different particle size.

It is further understood that the cutting system 12 could have its own control unit, different from the control unit CU, and be configured to control the cutting system 12, in particular each component of the cutting system, for example the cutting devices 19, 19′, 21, 21′, (when present) the support structure 24, (when present) the deflector assembly 27, etc.

According to a further aspect of the present invention there is proposed a cutting method of a layer S of ceramic powder material having a modulus of rupture that is smaller than about 10 N/mm², in particular smaller than about 8 N/mm², measured in accordance with UNI EN ISO 10545-4:2019 Ceramic tiles—Part 4:Determination of the modulus of rupture and the breaking strength and advantageously but not in limiting manner a loss on ignition (which is a measure of the weight variation of a dried sample measured at about 100° C. after it has been heated to a high temperature above 1000° C. causing combustion and volatilization of part of its content) that is ranging from about 1% to about 80% of the initial weight.

As mentioned above with reference to the plant 1, the term “layer S of ceramic powder material” means a layer comprising (in particular, consisting of) ceramic powder CP which has been compacted by means of the compaction device 5 but not yet fired. In detail, the “layer S of ceramic powder material”, in some cases, comprises (in particular, coincides with) the band of compacted ceramic powder KP or its part, in other cases, it comprises (in particular, coincides with) the dried band of ceramic powder KP′ or with the enamelled band of ceramic powder KP″ or their part and in other cases it comprises (in particular, coincides with) the enamelled band of ceramic powder KP″′ or its part.

The cutting method comprises: a moving step, during which the layer S of ceramic powder material is moved by a conveyor assembly 7 along a given path P in a moving direction A through a cutting station 13; and a cutting step, during which at least one water-jet cutting device 21 cuts the layer S of ceramic powder material along a direction D1, which is orthogonal in particular transverse to the moving direction A so as to obtain at least a portion P1 of said layer S. Advantageously but not in a limiting manner, during this cutting step at least a second water-jet cutting device 19 cuts the layer S of ceramic powder material or its portion P1 along a direction D2, which is parallel to the moving direction A, so as to cut the layer S of ceramic powder material or its portion P1 and obtain a plurality of articles of ceramic powder material MCP.

As mentioned above in relation to the plant 1, advantageously, the water-jet cutting devices 19, 21 each comprise a respective nozzle configured to dispense a jet G of water under pressure (in particular, having a pressure that is greater than about 1500 bar; in particular, than about 3000 bar; even more in particular than about 3600 bar) which, during the cutting step the layer S intercepts and cuts the layer S of ceramic powder material (in particular a surface, advantageously an upper surface, of the layer S of ceramic powder material).

Advantageously but not in a limiting manner, during the cutting step each cutting device 19, 21 dispenses a jet G of water under pressure comprising (in particular, made up of) pure water and at most about 10 g/l (in particular, at most about 5 g/l; even more in particular, at most about 2 g/l) of solid particles. Even more advantageously but not in a limiting manner, during this cutting step, each cutting device 19, 21 dispenses a jet G of water under pressure comprising (in particular, made up of) pure water and from about 0 (excluded) g/l (in particular, from about 0.3 g/l) to about 10 g/l (in particular, to about 5 g/l; even more in particular, to about 2 g/l) of solid particles. Such solid particles advantageously have an equivalent diameter which is smaller than about 10 μm (in particular, smaller than about 1 μm.

The fact that the water jet G is substantially made up of pure water with a minimum percentage of particulate matter allows, unlike some well-known water-jet cutting systems (for example for cutting fired ceramic articles) that envisage using water having a high amount of abrasives in its inside, to recover the water of the jet G of water under pressure after carrying out the cut, and to reuse it possibly by re-introducing it in the manufacturing cycle of the ceramic articles T (as explained above), for example inside the mill or to wash other parts of the plant 1, since this waste water is substantially clean water that contains, at most, dissolved or suspended ceramic powder material in its inside.

Advantageously, but not in a limiting manner, the method comprises a recovery step, which is (at least partially) subsequent to the cutting step, during which the water of the jet G of water under pressure dispensed during the cutting step is recovered to be reused, for example by re-introducing it in the manufacturing cycle of the ceramic articles T or to wash the manufacturing plant 1 to manufacture the ceramic articles T or its part.

Advantageously but not in a limiting manner, the cutting step comprises a longitudinal cutting sub-step and a transverse cutting sub-step, which is (at least partially) subsequent to the longitudinal cutting step. In particular (as already explained in relation to the plant 1), advantageously, during the cutting sub-step, the aforementioned at least one water-jet cutting device 19 arranged at a longitudinal cutting site 20 cuts the layer S of ceramic powder material along the longitudinal direction D2, while this layer S of ceramic powder material is moved along the given path P through the longitudinal cutting site 20; while during the transverse cutting sub-step, the aforementioned at least one water-jet cutting device 21 cuts the layer S of ceramic powder material along the transverse direction D1.

Even more advantageously but not in a limiting manner, during the longitudinal cutting sub-step, two water-jet cutting devices 19 and 19′ (advantageously of the type described above in relation to the plant 1) are arranged in the longitudinal cutting site 20 substantially side by side with each other transversely to the moving direction A (in particular, in a fixed position) so as to dispense the respective jet G of water at two fixed points of this longitudinal cutting site 20, so as to intercept the layer S of ceramic powder material that moves along the moving direction A along two substantially linear and parallel cutting paths. In detail, as already said for the plant 1, the two cutting devices 19, 19′ are preferably but not necessarily spaced apart from each other so as to perform the so-called trimming operation obtaining the aforementioned portion P1 or so as to obtain three (or more) portions, in particular in three strips.

According to some advantageous but not limiting embodiments of the method (such as the one schematically shown in FIG. 3), during the transverse cutting sub-step, the layer S of ceramic powder material is moved along the given path P, through the transverse cutting site 22, and the water-jet cutting device 21 dispenses the aforementioned jet G of water under pressure, while translating (advantageously but not in a limiting manner as explained above in relation to the plant 1) along a direction D3, which is oblique relative to the moving direction A and to the transverse direction D1, so as to cut the layer S of ceramic powder material along the said first direction D1 “on the fly”, that is while both the layer S of ceramic powder material and the water-jet cutting device 21 are in motion. As already explained in relation to the plant 1, advantageously but not in a limiting manner, during this transverse cutting sub-step, the water-jet cutting device 21 moves along the third direction D3 at a translation speed VT which is a function of the inclination of the direction D3 relative to said moving direction A. Even in more detail, according to some advantageous but not limiting embodiments, the cutting speed VT is proportional to the speed at which the layer S of ceramic powder material is moved along the moving direction A and the proportionality constant is a function of the inclination of said direction D3 relative to said moving direction A, even more in particular it is equal to about the reciprocal of the cosine of the angle α of inclination that the direction D3 forms relative to the moving direction A. Advantageously but not in a limiting manner, this direction D3 is inclined relative to the moving direction A by an angle α ranging from about 45° to about 80°. In this case, advantageously but not in a limiting manner, the cutting step is performed on a band of compacted ceramic powder KP but not yet fired or dried, i.e. in this case the layer S of ceramic powder material coincides with the band of compacted ceramic powder KP.

Advantageously, but not in a limiting manner, according to some variants (such as the one shown in FIG. 4), during the transverse cutting sub-step the conveyor assembly 7 (in particular, the conveyor device 17) stops the layer S of ceramic powder material at the transverse cutting site 22 and the second water-jet cutting device 21 dispenses the jet G of water under pressure while moving (advantageously but not in a limiting manner, as already explained above in relation to the plant 1) along a cutting path PT that develops along the transverse direction D1 so as to intercept and cut the layer S of ceramic powder material and obtain articles of ceramic powder material MCP.

Alternatively, according to other advantageous but not limiting variants (such as those shown in FIGS. 5 and 6), during the moving step the layer S of ceramic powder material is moved along a segment T1 of the moving path P and at least along a second segment T2 of the moving path P, which is arranged downstream of the first segment T1; during the longitudinal cutting sub-step the layer S of ceramic powder material is moved along the segment T1 of the moving path P and is cut by the water-jet cutting device 19 (in particular by the cutting devices 19, 19′) to obtain at least a portion P1 of the layer S of ceramic powder material having a first orientation O1 such that a main development direction thereof is substantially parallel to the moving direction A; and during the transverse cutting sub-step, said portion P1 of the layer S of ceramic powder material is moved along the second segment T2 with a second orientation O2, which is rotated by about 90° relative to the first orientation O1 so that the main development direction of the (in particular, of each) portion P1 of the layer S of ceramic powder material is substantially perpendicular, in particular substantially transverse, to said moving direction A of the second segment T2 of the given path P, and the water-jet cutting device 21, which is fixedly arranged at the transverse cutting site 22 intercepts and cuts said portion P1 that moves along the segment T2 with said second orientation O2. As already said in relation to the plant 1, in particular to the cutting system 12, in this case during the transverse cutting step two water-jet cutting devices 21, 21′ which are arranged substantially side by side with each other transversely to the moving direction A dispense the respective jet G of water at two fixed points of the transverse cutting site 22 while the (in particular, each) portion P1 of the layer S of ceramic powder material moves in the moving direction A along the segment T2 of the given path P.

Even in more detail, as already mentioned in relation to the plant 1, advantageously but not in a limiting manner, according to some non-limiting embodiments (such as the one shown in FIG. 5), the method comprises a deflection step that is at least partially subsequent to the transverse cutting sub-step and at least partially prior to the longitudinal cutting sub-step, during which a deflection assembly 27 (advantageously of the type described above) rotates by about 90° the (in particular each) portion P1 of the layer S of ceramic powder material, so as to pass from the first orientation O1 to the second orientation O2.

According to yet a further aspect of the present invention there is proposed a manufacturing process to manufacture ceramic articles T (such as those described above).

Said manufacturing process to manufacture ceramic articles T comprises a feeding step, during which the ceramic powder CP is fed to an input station 4; a compaction step, during which said ceramic powder CP is compacted by a compaction device 5 which is arranged at a compaction station 6, said compaction device 5 (advantageously but not in a limiting manner of the type described above) applies a compaction pressure on the ceramic powder so as to obtain a band of compacted ceramic powder KP; a cutting step, implemented in accordance with the cutting method above, during which the aforementioned layer S of ceramic powder material (for which the above considerations apply) is cut in order to obtain a plurality of articles of ceramic powder material CP; a firing step, during which the articles of ceramic powder material CP are fired in a firing kiln 14, heating them up to a temperature of about 1000-1300° C., so as to obtain ceramic articles T; and a conveying step, during which a conveyor assembly 7 (advantageously but not in a limiting manner of the type described above) which extends along a given path P in a moving direction A conveys the ceramic powder CP from an input station 4 to the compaction station 6, the band of compacted ceramic powder KP out of the compaction station 6, and the layer S of ceramic powder material at least through the cutting station 13.

In detail, advantageously but not necessarily, the cutting step performed according to one of the embodiments described above is (at least partially) simultaneous with the conveying step, (at least partially) subsequent to the compaction step and (at least partially) prior to the firing step.

According to some advantageous but not limiting embodiments, the manufacturing process further comprises a drying step, during which a drier imposes a temperature of about 120-300° C. on the band of compacted ceramic powder KP (or on the already formed article of ceramic powder material MCP) so as to obtain a dried band of ceramic powder KP′ (or to dry the article of ceramic powder material MCP). In addition, according to some non-limiting embodiments, the manufacturing process to manufacture ceramic articles T also comprises an enamelling step that is at least partially subsequent to the drying step and at least partially prior to the cutting step, during which the enamel is applied on the dried band of ceramic powder KP′ (or on the already dried article of ceramic powder material MCP) so as to obtain an enamelled band of ceramic powder KP″ (or an enamelled article of ceramic powder material MCP).

According to other embodiments of the present invention (like for example those shown in FIGS. 4, 5 and 6), the cutting step is at least partially subsequent to the drying step and, when present, to the enamelling step, i.e. the layer S of ceramic powder material comprises (in particular, coincides with) the dried band of ceramic powder KP′ or the enamelled band of ceramic powder KP″ or their part.

According to yet other advantageous but not limiting embodiments such as the one shown in FIG. 2A, the manufacturing process to manufacture ceramic articles T comprises an enamelling step (at least partially) prior to the cutting step, during which a decoration unit 16 applies enamel on the band of compacted ceramic powder KP so as to obtain an enamelled band of ceramic powder KP″′, and a drying step, (at least partially) subsequent to the cutting step, during which a drier 15 heats the articles of ceramic powder material MCP up to a temperature of about 120-300° C. so as to obtain enamelled and dried articles of ceramic powder material MCP′. In this case, the layer S of ceramic powder material coincides with the enamelled band of ceramic powder KP″′.

In particular, as already mentioned above in relation to the plant 1 and to the cutting method, when the layer S of ceramic powder material coincides with the dried band of compacted ceramic powder KP′, the cutting step (which advantageously but not in a limiting manner—as better explained above-provides for a longitudinal cutting sub-step in which the layer S of ceramic powder material is cut to obtain the portion P1 and a transverse cutting sub-step which may envisage that the portion P1 is stopped at the cutting site 22 and that the—each—cutting device 21 and 21′—cuts said portion P1 while moving along the cutting path PT in the transverse direction D1, or that the portion P1 is cut, by fixed cutting devices 21, 1′ while moving along the segment T2 of the given path P) is (at least partially) subsequent to the drying step and when provided for to the enamelling step.

Alternatively, according to other non-limiting embodiments (such as the one schematically shown in FIG. 2A), when the layer S of ceramic powder material coincides with the enamelled band of ceramic powder KP″′, the cutting step is (at least partially subsequent) to the enamelling step and (at least partially preceding) to the drying step.

The cutting method and the plant 1 and the manufacturing process to manufacture ceramic articles T of the present invention have numerous advantages, including the following.

The present invention makes it possible to cut a layer S of ceramic powder material having a thickness varying from about 3 mm, to about 50 mm, in particular to about 30 mm, making the cut with high precision, without inducing the occurrence of surpluses, irregularities or burrs along the cut edge. In addition, the present invention ensures high efficiency by allowing the cutting to be carried out at a speed ranging from about 1 metre per minute to about 30 metres per minute as the characteristics vary, in terms of composition of the ceramic powder material, physical state—before or after drying—and/or molecular structure—e.g., crystalline, glassy, dissolved, etc.—, of the thickness of the layer S of ceramic powder material.

Furthermore, the use of water-jet cutting devices 19, 19′, 21, 21′ for cutting such as those described above, which do not produce waste powder, means that the present invention can also be used (as explained above) to cut ceramic powder material already dried and/or already enamelled without risking compromising its quality. It follows that the present invention, by envisaging the possibility of cutting a dried band of ceramic powder KP′ or an enamelled band of ceramic powder KP″, allows a unique processing for the entire layer/band of ceramic powder material regardless of the type (in particular the format) of ceramic article T to be obtained.

In addition, relative to some known cutting systems and methods that provide for cutting the already fired ceramic articles, the present invention allows cutting ceramic powder material which is less resistant than the already fired material whose cutting can be done much faster and without the use of abrasive material, with all the consequent advantages in terms of environment and recovery of the waters used by the cutting devices 19, 19′, 21, 21′. In addition, cutting before firing allows a faster firing, having to fire articles of ceramic material MCP having smaller dimensions.

1. A cutting method of a layer (S) of ceramic powder material having a modulus of rupture that is smaller than about 10 N/mm², in particular smaller than about 8 N/mm²; the cutting method comprises:
a moving step, during which said layer (S) of ceramic powder material is moved by a conveyor assembly along a given path (P) in a moving direction (A) through at least one cutting station; and
a cutting step, during which at least one first water-jet cutting device cuts said layer (S) of ceramic powder material along a first direction (D1), which is orthogonal (in particular, transverse) to the moving direction (A), in order to cut said layer (S) of ceramic powder material and obtain a plurality of articles of ceramic powder material (MCP);
said at least one first water-jet cutting device comprising a respective nozzle configured to dispense a jet (G) of water under pressure which, during said cutting step, intercepts and cuts said layer (S) of ceramic powder material;
said jet (G) of water under pressure comprising (in particular, being made up of) pure water and from about 0 (excluded) g/l (in particular, from about 0.3 g/l) to about 10 g/l (in particular, to about 5 g/l; even more in particular, to about 2 g/l) of solid particles;
said solid particles of said jet (G) of water under pressure having an equivalent diameter, which is smaller than about 10 μm (in particular, smaller than about 1 μm).

2. The cutting method according to claim 1, wherein:
during said cutting step, said at least a second water-jet cutting device cuts said layer (S) of ceramic powder material along a second direction (D2) which is parallel to the moving direction (A) in order to obtain a plurality of articles of ceramic powder material (MCP); said at least a second water-jet cutting device comprises a respective nozzle configured to dispense a jet (G) of water under pressure which, during said cutting step, intercepts and cuts said layer (S) of ceramic powder material; and
said jet (G) of water under pressure comprises (in particular, is made up of) pure water and from about 0 (excluded) g/l (in particular, from about 0.3 g/l) to about 10 g/l (in particular, to about 5 g/l; even more in particular, to about 2 g/l) of solid particles; in particular, said solid particles of said jet (G) of water under pressure have an equivalent diameter which is smaller than about 10 μm (in particular, smaller than about 1 μm).

3. The cutting method according to claim 2, wherein said cutting step comprises:
a first cutting sub-step, during which said at least one second water-jet cutting device, which is arranged at a first cutting site of said cutting station, cuts said layer (S) of ceramic powder material along said second direction (D2), while said layer (S) of ceramic powder material is moved along said given path (P) through said first cutting site; and
a second cutting sub-step, which is at least partially subsequent to said first cutting sub-step and during which said at least one first water-jet cutting device, which is arranged at a second cutting site of said cutting station, cuts said layer (S) of ceramic powder material along said first direction (D1).

4. The cutting method according to claim 3, wherein, during said second cutting sub-step, said layer (S) of ceramic powder material is moved along said given path (P) through said second cutting site and said at least one first water-jet cutting device dispenses said jet (G) of water under pressure while it translates along a third direction (D3), which is oblique relative to said moving direction (A) and to said first direction (D1), so as to cut said layer (S) of ceramic powder material along said first direction (D1);
in particular, said at least one first water-jet cutting device moves along said third direction (D3) at a translation speed (VT), which is a function of the inclination of said third direction (D3) relative to said moving direction (A).

5. The cutting method according to claim 3, wherein during said cutting sub-step, said conveyor assembly stops said layer (S) of ceramic powder material at said second cutting site, and said at least one first water-jet cutting device dispenses said jet (G) of water under pressure while it moves along a cutting path (PT), which develops along said first direction (D1), so as to intercept said layer (S) of ceramic powder material and cut the layer (S) of ceramic powder material.

6. The cutting method according to claim 3, wherein:
during said moving step, said layer (S) of ceramic powder material is moved along a first segment (T1) of the moving path (P) and at least along a second segment (T2) of the moving path (P), which is arranged downstream of said first segment (T1);
during said first cutting sub-step, said layer (S) of ceramic powder material is moved along the first segment (T1) of the moving path (P) and is cut by said at least one second water-jet cutting device so as to obtain at least one portion (P1) of said layer (S) of ceramic powder material having a first orientation (O1); and
during said second cutting sub-step, said portion (P1) of said layer (S) of ceramic powder material is moved along said second segment (T2) with a second orientation (O2), which is rotated by about 90° relative to the first orientation (O1), and said at least one first water-jet cutting device, which is arranged at said second cutting site, cuts said portion (P1) of said layer (S) of ceramic powder material moving along said second segment (T2) with said second orientation (O2).

7. The cutting method according to claim 6 and comprising:
a deflection step, which is at least partially subsequent to said first cutting sub-step and is at least partially prior to said second cutting sub-step,
during which a deflection assembly rotates said at least one portion (P1) of said layer (S) of ceramic powder material by about 90° so as to pass from said first orientation (O1) to said second orientation (O2).

8. A manufacturing process to manufacture ceramic articles (T), which comprises the method to cut a layer (S) of ceramic powder material having a modulus of rupture that is smaller than about 10 N/mm² according to claim 1, the manufacturing process comprises:
a feeding step, during which ceramic powder (CP) is fed to an input station;
a compaction step, during which said ceramic powder (CP) is compacted by a compaction device, which is arranged at a compaction station, said compaction device applies a compaction pressure to the ceramic powder (CP) so as to obtain a band of compacted ceramic powder (KP);
said cutting step, during which said layer (S) of ceramic powder material is cut in order to obtain a plurality of articles of ceramic powder material (MCP);
a firing step, during which the articles of ceramic powder material (MCP) are fired in a firing kiln so as to obtain ceramic articles (T); and
a conveying step, during which a conveyor assembly, which extends along a given path (P) in a moving direction (A), conveys said ceramic powder (CP) from an input station to said compaction station, said band of compacted ceramic powder (KP) at least out of said compaction station and said layer (S) of ceramic powder material at least through said cutting station;
said cutting step being at least partially simultaneous with said conveying step, at least partially subsequent to said compaction step and at least partially prior to said firing step.

9. The manufacturing process to manufacture ceramic articles (T) according to claim 8, wherein:
said cutting step is carried out wherein during said cutting sub-step, said conveyor assembly stops said layer (S) of ceramic powder material at said second cutting site, and said at least one first water-jet cutting device dispenses said jet (G) of water under pressure while it moves along a cutting path (PT), which develops along said first direction (D1), so as to intercept said layer (S) of ceramic powder material and cut the layer (S) of ceramic powder material; and
the manufacturing process to manufacture ceramic articles (T) further comprises a drying step, during which a drier heats said band of compacted ceramic powder (KP) up to a temperature of about 120-300° C. so as to obtain a dried band of ceramic powder (KP′);
said cutting step being at least partially subsequent to said drying step.

10. The manufacturing process to manufacture ceramic articles (T) according to claim 9 and comprising an enameling step, which is at least partially subsequent to said drying step and during which a decoration unit applies enamel on said dried band of ceramic powder (KP′) so as to obtain an enameled band of ceramic powder (KP″);
said cutting step being at least partially subsequent to said enameling step; and
said layer (S) of ceramic powder material coinciding with said enameled band of ceramic powder (KP″).

11. The manufacturing process to manufacture ceramic articles (T) according to claim 8, wherein:
said cutting step is carried out wherein during said cutting sub-step, said conveyor assembly stops said layer (S) of ceramic powder material at said second cutting site, and said at least one first water-jet cutting device dispenses said jet (G) of water under pressure while it moves along a cutting path (PT), which develops along said first direction (D1), so as to intercept said layer (S) of ceramic powder material and cut the layer (S) of ceramic powder material; and
said manufacturing process to manufacture ceramic articles (T) further comprises an enameling step, which is at least partially prior to said cutting step and during which a decoration unit applies enamel on said band of compacted ceramic powder (KP) so as to obtain an enameled band of ceramic powder (KP′″), and a drying step, which is at least partially subsequent to said cutting step and during which a drier heats the articles of ceramic powder material (MCP) up to a temperature of about 120-300° C. so as to obtain enameled and dried articles of ceramic powder material (MCP′);
said layer (S) of ceramic powder material coinciding with the enameled band of ceramic powder (KP″′).

12. A manufacturing plant to manufacture ceramic articles (T), the manufacturing plant comprises:
a feeding assembly, which is configured to feed ceramic powder (CP) at an input station;
a compaction device, which is arranged at a compaction station and is configured to apply a compaction pressure to said ceramic powder (CP) in order to obtain a band of compacted ceramic powder (KP);
a cutting system, which is arranged at a cutting station and is configured to cut a layer (S) of ceramic powder material so as to obtain a plurality of articles of ceramic powder material (MCP);
a firing kiln, which is arranged downstream of said cutting system along said moving direction (A) to fire said articles of ceramic powder material (MCP) so as to obtain ceramic articles (T); and
a conveyor assembly to convey said ceramic powder (CP) along a given path (P) in a moving direction (A) from said input station to said compaction station, said band of compacted ceramic powder (KP) at least out of said compaction station, said layer (S) of ceramic powder material at least through said cutting station and said articles of ceramic powder material (MCP) from the cutting station to the firing kiln;
the manufacturing plant to manufacture ceramic articles (T) is characterized in that said cutting system is configured to cut said layer (S) of ceramic powder material, which has a modulus of rupture that is smaller than about 10 N/mm², in particular smaller than about 8 N/mm²; and in that said cutting system comprises at least one first water-jet cutting device, which is configured to cut said layer (S) of ceramic powder material along a first direction (D1), which is orthogonal (in particular, transverse) to the moving direction (A), and comprises a respective nozzle which is arranged to dispense a jet (G) of water under pressure, comprising (in particular, made up of) pure water and from about 0 (excluded) g/l (in particular, from about 0.3 g/l) to about 10 g/l (in particular, to about 5 g/l; even more in particular, to about 2 g/l) of solid particles, towards said layer (S) of ceramic powder material so as to intercept and cut said layer (S) of ceramic powder material; said solid particles of said jet (G) of water under pressure have an equivalent diameter, which is smaller than 10 μm (in particular, smaller than about 1 μm).

13. The manufacturing plant to manufacture ceramic articles (T) according to claim 12, wherein:
said cutting system comprises at least one second water-jet cutting device, which is configured to cut said layer (S) of ceramic powder material along a second direction (D2), which is parallel to the moving direction (A), and comprises a respective nozzle, which is arranged to dispense a jet (G) of water under pressure, comprising (in particular, made up of) pure water and from about 0 (excluded) g/l (in particular, from about 0.3 g/l) to about 10 g/l (in particular, to about 5 g/l even more in particular, to about 2 g/l) of solid particles, towards said layer (S) of ceramic powder material so as to intercept and cut said layer (S) of ceramic powder material and obtain a plurality of articles of ceramic powder material (MCP);
said solid particles of said jet (G) of water under pressure have an equivalent diameter, which is smaller than 10 μm (in particular, smaller than about 1 μm).

14. The manufacturing plant to manufacture ceramic articles (T) according to claim 12, wherein said (each) nozzle comprises an outlet hole having a diameter that is smaller than about 0.10 mm (in particular, smaller than about 0.15 m) and is configured to dispense said jet (G) of water under pressure at a pressure that is greater than about 1500 bar; in particular, greater than about 3000 bar; even more in particular, greater than about 3600 bar.

15. The manufacturing plant to manufacture ceramic articles (T) according to claim 14, wherein:
said conveyor assembly comprises at least one conveying device, which defines a conveying plane to receive and move said layer (S) of ceramic powder material through said cutting station;
said at least one first water-jet cutting device and said at least one second water-jet cutting device being arranged above said conveying plane so that said hole of said nozzle of each water-jet cutting device is at a distance that is smaller than about 15 mm, in particular smaller than about 10 mm, from said layer (S) of ceramic powder material (in particular, from an upper surface of said layer (S) of ceramic powder material).

16. The manufacturing plant to manufacture ceramic articles (T) according to claim 12 and comprising a recovery assembly, which is configured to recover the water of the jet (G) of water under pressure of each water-jet cutting device of said cutting system.

17. The manufacturing plant to manufacture ceramic articles (T) according to claim 13, wherein said cutting system comprises:
a support, which at least partly extends above said conveyor assembly at a first cutting site and carries said at least one second water-jet cutting device so that, once it has been operated, it dispenses the respective jet (G) of water under pressure so as to intercept and cut said layer (S) of ceramic powder material, when said layer (S) of ceramic powder material is located at (in particular, goes through the area of) said first cutting site; and
a support structure, which carries said at least one first water-jet cutting device in a sliding manner and can be operated so as to allow said at least one first water-jet cutting device to translate along a third direction (D3), which is oblique relative to said moving direction (A) and to said first direction (D1);
in particular, said support structure can be operated so as to allow said at least one first water-jet cutting device to move along said third direction (D3) at a translation speed (VT), which is a function of the inclination of said third direction (D3) relative to said moving direction (A).

18. The manufacturing plant to manufacture ceramic articles (T) according to claim 13, wherein the cutting system comprises:
a support, which at least partly extends above said conveyor assembly at a first cutting site and carries said at least one second water-jet cutting device so that, once it has been operated, it dispenses the respective jet (G) of water under pressure so as to intercept and cut said layer (S) of ceramic powder material, when said layer (S) of ceramic powder material is located at (in particular, goes through the area of) said first cutting site; and
a support structure, which carries said at least one first water-jet cutting device in a sliding manner in the area of a second cutting site and can be operated so as to allow said first water-jet cutting device to translate along a cutting path (PT), which extends along said second direction (D2).

19. The manufacturing plant to manufacture ceramic articles (T) according to claim 13, wherein said conveyor assembly comprises a first conveyor device, which extends along a first segment (T1) of said given path (P) through at least said first cutting site, and a second conveyor device, which extends along a second segment (T2) of said given path (P) downstream of the segment (T1) through at least said second cutting site, and the cutting system comprises:
a first support, which at least partly extends above said conveyor assembly and carries said at least one second water-jet cutting device so that, once it has been operated, it dispenses the respective jet (G) of water under pressure so as to intercept and cut said layer (S) of ceramic powder material, when said layer (S) of ceramic powder material is located (in particular, goes through) along said segment (T1), in order to obtain at least one portion (P1) of said layer (S) of ceramic powder material having a first orientation (O1); and
a second support, which at least partly extends above said conveyor assembly and carries said at least one first water-jet cutting device so that, once it has been operated, it dispenses the respective jet (G) of water under pressure so as to intercept and cut said at least one portion (P1) of said layer (S) of ceramic material, when it is located (in particular, goes through) along said segment (T2) of the given path (P) with a second orientation (O2), which is rotated by about 90° relative to the first orientation (O1).

20. The manufacturing plant to manufacture ceramic articles (T) according to claim 19, wherein:
said first conveyor device comprises (in particular, coincides with) said further conveyor device; said second segment (T2) and said first segment (T1) develop one after the other and the cutting system comprises a deflection assembly, which is configured to rotate said at least one portion (P1) of said layer (S) from said orientation (O1) to said second orientation (O2).

21. The manufacturing plant according to claim 18, further comprising:
a drier, which is arranged downstream of said cutting system and upstream of said firing kiln along said moving direction (A) in order to dry said layer (S) of ceramic powder material; and
a decoration unit, which is arranged downstream of said drier and upstream of said firing kiln along said moving direction (A) and is configured to apply enamel on said layer (S) of ceramic powder material.

22. The manufacturing plant according to claim 18, further comprising:
a drier, which is arranged upstream of said firing kiln along said moving direction (A) in order to dry said layer (S) of ceramic powder material; and
a decoration unit, which is arranged upstream of said drier along said moving direction (A) and is configured to apply enamel on said layer (S) of ceramic powder material;
said cutting unit being arranged between said decoration unit and said drier.
